(19) United States
(12) Patent Application Publication
(10) Pub. No.: US 2015/0351414 A1
(43) Pub. Date: Dec. 10, 2015

(54) PREPARATION OF DOUGH FOR BAKING

(71) Applicant: WARBURTONS LTD, Lancashire (GB)

(72) Inventors: Mark Borland, Lancashire (GB); Michael Briggs, Lancashire (GB); Colin Kelly, Lancashire (GB); Ian Price, Lancashire (GB); Dylan Pritchard, Lancashire (GB)

(73) Assignee: Warburtons Ltd., Lancashire (GB)

(21) Appl. No.: 14/760,433

(22) PCT Filed: Jan. 13, 2014
(86) PCT No.: PCT/GB2014/050088

§ 371 Date: Jul. 10, 2015

(30) Foreign Application Priority Data
Jan. 14, 2013 (GB) 1300556.6

(51) Int. Cl. A21D 8/02; A21C 3/06

(52) U.S. Cl. CPC A21D 8/02; A21C 3/06

(57) ABSTRACT

The present invention relates to a process for preparing dough for baking, the process comprising: a) reducing a unit dough piece in thickness, b) coiling the reduced dough piece, and c) repeating steps a) and b) at least once; dough so produced; a process for preparing a baked product using said dough; and apparatus for preparing dough for baking.

### FIELD OF THE INVENTION

The invention relates to methods for making bread and in particular to processing or developing dough for use in making bread.

### BACKGROUND TO THE INVENTION

At present dough preparation involves several stages. In a typical method the stages include: high speed mixing; dough dividing; conical moulding; first proof; final moulding; proofing; and baking.

It would be of advantage to provide a process which is able to reduce the number of process steps whilst at the same time to be able to produce bread which is of the same or better quality (e.g. in terms of at least one of increased volume, improved crumb softness, greater crumb resilience, improved crumb brightness, increased cell numbers, smaller cell diameter and thinner cell walls-as that provided by traditional dough making processes.

### STATEMENTS OF THE INVENTION

According to the present invention there is provided a process for preparing dough for baking, the process comprising:
a) reducing a unit dough piece in thickness,
b) coiling the reduced dough piece; and
c) repeating steps a) and b).

Suitably, steps a and b may be repeated until the desired dough consistency which achieves the desired enhanced final product attributes is achieved.

Preferably, each repetition of coiling step b) is applied to the dough at an angle to the previous coiling step. Suitable, the angle compared with the previous coiling step may be at least 45°. More preferably the angle is about 90°.

Preferably, the dough piece and/or the coiled sheet is subjected to reduction in one step so that the thickness of the dough is reduced by a reduction ratio of at least 8:1. More preferably the reduction ratio is about 10:1, preferably 12:1.

Preferably, the dough piece, before reduction at each process step a), has a thickness of at least 25 mm. More preferably, the dough piece has a thickness of about 50 mm or greater. In one embodiment, the dough piece has a thickness of about 25 to 75 mm

Preferably, the dough is reduced in thickness is step a) by means of one or more (preferably a set of) reducing rollers.

Preferably, the coiled dough resulting from each coiling step b) is turned through an angle before presentation to the reducing rollers. Suitable, the angle is at least 45°. More preferably the angle is about 90°.

Preferably, steps a) and b) are repeated at least twice or at least three times.

Preferably the dough is conveyed along a flow path which includes changes of direction corresponding to said angle.

Preferably, the dough is allowed to rest after each coiling step.

Preferably the resting time is from 0 to 5 minutes, preferably 2 to 4 minutes, more preferably 3 minutes.

The present invention also provides a process for preparing a baked product (e.g. bread) comprising the step of baking a dough produced by the process of the present invention.

The present invention further provides dough and/or a baked product (e.g. bread) prepared by the processes of the present invention.

The present invention further provides apparatus for preparing dough for baking, the apparatus comprising means for reducing a dough piece into a sheet, means for coiling the sheeted dough piece, means for presenting the coiled dough piece longitudinally to further means for reducing a dough piece and means for coiling said further sheet.

The present invention involves the following key process steps:

1. Dough piece reduction (Without wishing to be bound by theory, it is believed that rapid reduction of the thickness of the dough sheet provides increased oxidation and/or releases stored energy).

2. Dough sheet coiling (without wishing to be bound by theory it is believed immediate coiling of the dough piece after reduction allows utilisation of released energy).

3. Dough resting.

4. Multiple stage dough layering and reduction (each stage being preferably carried out at an angle, more preferably at about 90°, to the previous stage).

The present invention utilises the above steps in providing a dough by means of a compact and focused process and apparatus.

In effect, the process of the present invention reduces the steps in dough development to the following: high speed mixing; dough dividing; multiple moulding; final proof; and baking. Thus, advantageously, the need for conical moulding is removed.

Without wishing to be bound by theory, it is believed that dough oxidisation is a key function of the process. In the process of the present invention, this is provided by reducing a dough in thickness by, for instance, use of reducing rollers followed by the (preferably immediate) coiling of the reduced dough. The key action may be the exposure of a large surface area of the dough to air followed by (preferably immediate) coiling of the dough sheet. The oxidation function of the dough may be increased by the method of dough piece reduction and the multiple moulding aspect of the design.

Thus, the process of the present invention allows for a simplified process for preparing dough in which conical moulding is not longer necessary. Advantageously, the process of the present invention results in dough which when baked has the same and or improved quality compared with traditional processes involving conical moulding, wherein the quality is determined by one or more of the following properties: product volume (e.g. at least 1% or 2% or 3% or 4% or 5% increase), increase in cell number (e.g. at least 1% or 2% or 3% or 4% or 5% or 6% or 7% increase); reduction in cell wall thickness (e.g. 0.5% or 1% or 1.5% or 2% reduction) and reduction in cell diameter (e.g. at least 1% or 2% or 3% or 4% or 5% reduction).

### BRIEF DESCRIPTION OF THE DRAWINGS

The accompanying drawings are as follows:

FIG. 1 is a schematic drawing of a dough development process in accordance with the present invention;

FIG. 2 is a schematic representation of a first stage of a process for dough preparation in accordance with the present invention;

FIG. 3 is a schematic representation of the second stage of the dough process of the present invention;

FIG. 4 is a schematic representation of the third stage of the dough process in accordance with the present invention; and

### DETAILED DESCRIPTION OF THE INVENTION

The present invention will now be described, by way of example only, with reference to the accompanying drawings.

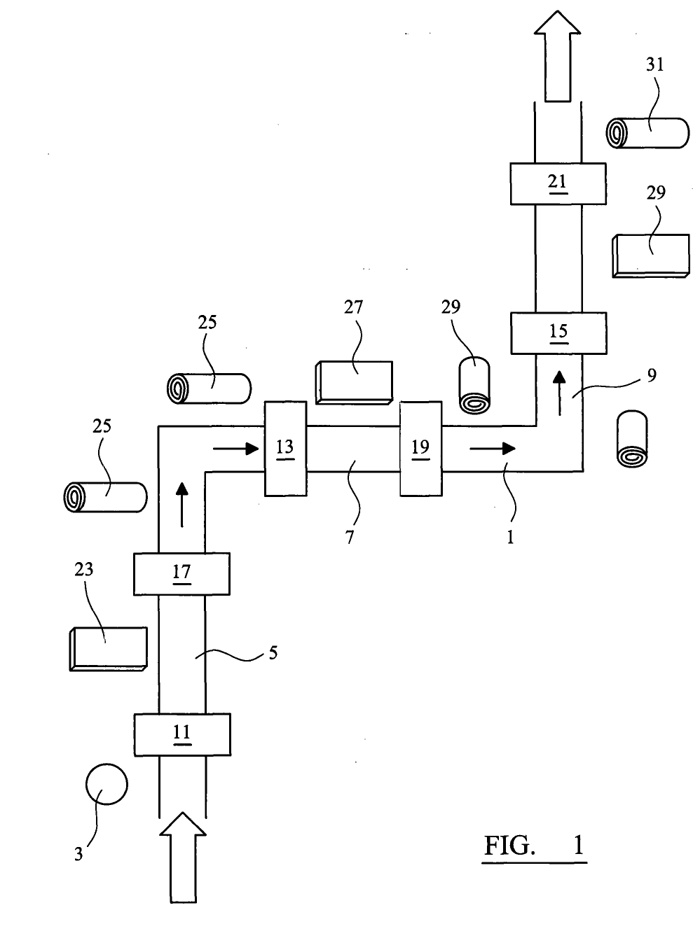

Referring to FIG. 1, a dough development process of the present invention includes a conveyer 1 which conveys dough pieces 3 along a path which includes a first linear section 5, through a 90° bend on to a second section 7 and then on to a further 90° bend (in the opposite direction to the first 90° bend) on to third section 9. On each section there is provided a set of reducing rollers 11, 13, 15 and a coiler 17, 19 and 21.

Dough piece 3 is first reduced in thickness and formed into a sheet 23 by means of reducing rollers 11 in the first section. Sheet 23 then proceeds through coiler 17 to form coil 25. Because of the bend between the first and second sections 5,7 of the conveyer, coiled sheet 25 is travelling longitudinally at the second section 7 where it is fed to reducing rollers 13 to form sheet 27.

Sheet 27 is then fed to coiler 19 on the second section of the conveyer and this results in a further coiled sheet 29 being produced with its longitudinal axis at right angles to conveyer section 7.

The further bend of the conveyer 1, between second 7 and third section 9, is such that the coiled sheet 29 proceeds, in the third section, longitudinally towards reducing rollers 15.

Reducing rollers 15 forms a further sheet 29 which is fed to coiler 21 from which coiled sheet 31 is produced.

The above described apparatus includes a conveyer having two turns through 90°. However, in other embodiments of the invention there may be a different number of turns, and consequently of pairs of reducing rollers and coilers.

Furthermore in other embodiments, the conveyer may be arranged so that each turn is in the same direction, resulting potentially in a continuous loop.

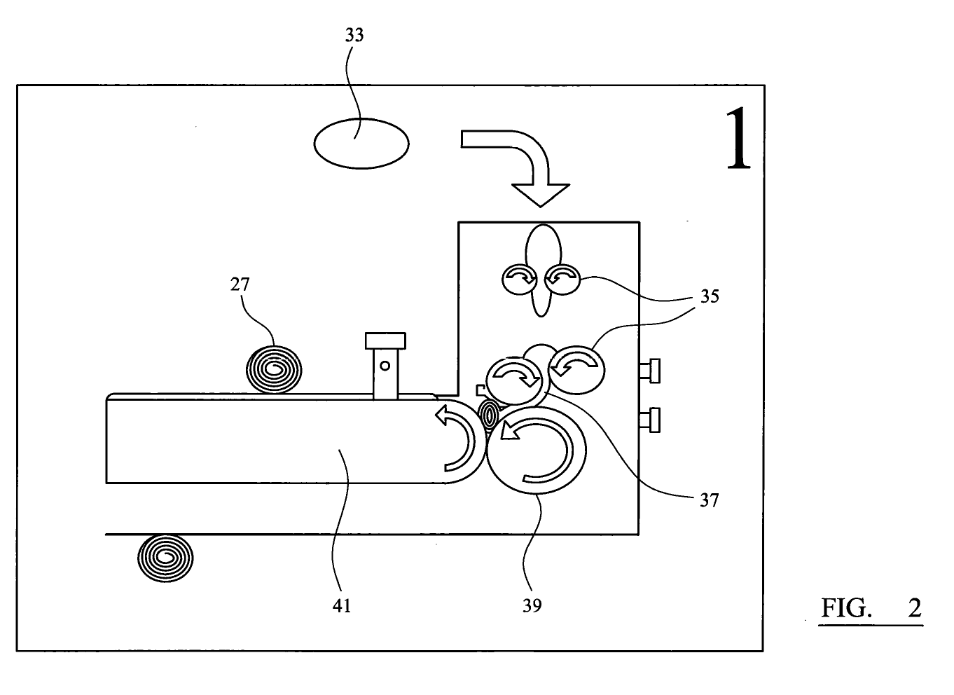

Referring to FIG. 2 of the accompanying drawings, there is illustrated a first sheeting and coiling stage of a process such as that described above.

A dough piece, having a weight of 910 g and a thickness of about 50 mm, is fed to a combined sheeting and coiling device. The dough 33 is passed through sheeting rollers 35 to form a sheet 36 which is coiled by means of a roller 39 and the curved end of conveyer 41, both rotating in the same direction. The resultant coil is then fed to the next stage during which time it is effectively resting for a period of about 3 minutes.

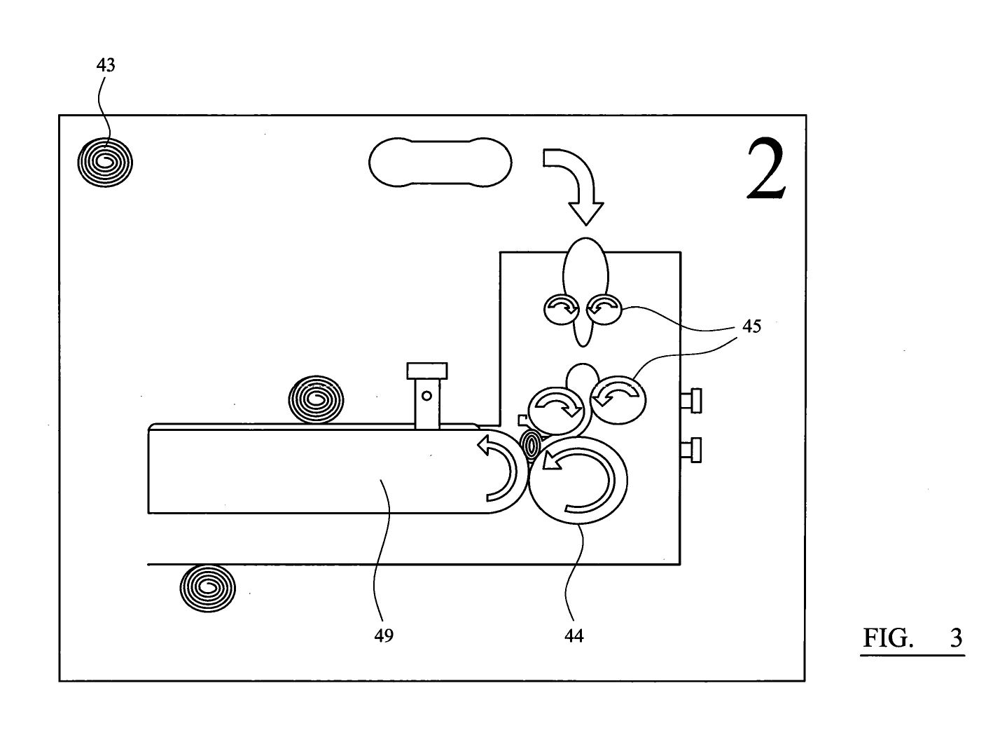

Referring to FIG. 3 of the accompanying drawings, the coiled dough 43 from the first stage is effectively turned through an angle of 90°, for instance, by changing its path of travel as illustrated above in connection with FIG. 1. The coiled dough is subjected to further reduction by means of rollers 45 and coiling by means of roller 47 and the curved end of conveyer 49 to produce a coiled dough 51 in which the longitudinal axis of the coil runs effectively at 90° to that of coiled dough 43. Again the dough is effectively allowed to rest for about 3 minutes before being presented to third stage apparatus.

The coiled dough 51 is first turned for a further 90° angle (see FIG. 1 as to how this might be achieved) and is fed to a further reduction and coiling device 53 similar to that described above with reference to FIGS. 2 and 3.

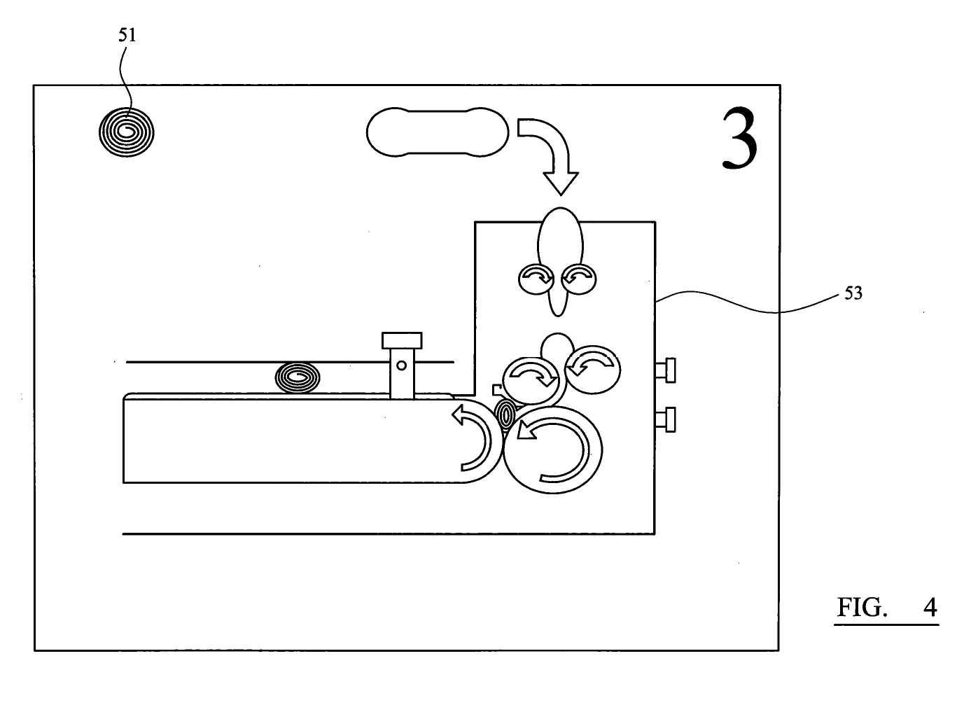

At each stage (FIGS. 2 to 4) the dough piece or coiled dough is subjected to a reduction ratio of about 12:1.

The sheet thickness at each stage is typically about 4 mm and the resultant coiled dough 55 is then conveyed to further stations where it is cut and/or moulded and the appropriate sized pieces are placed in baking pans.

1. A process for preparing dough for baking, the process comprising:
a) reducing a unit dough piece in thickness;
b) coiling the reduced dough piece; and
c) repeating steps a) and b) at least once.

2. A process according to claim 1, wherein each repetition of coiling step b) is applied to the dough at an angle to the previous coiling step.

3. A process according to claim 2, wherein the angle is about 90°.

4. A process according to claim 1, wherein the thickness of the dough piece and/or the coiled dough is subjected to reduction in one step by a reduction ratio of at least 8:1.

5. A process according to claim 4, wherein the reduction ratio is about 12:1.

6. A process according claim 1, wherein the dough piece or coiled dough piece prior to reduction in step a) has a thickness of at least 25 mm.

7. A process according to claim 6, wherein the dough piece has a thickness of at least 50 mm.

8. A process according to claim 1, wherein the dough is formed into a sheet by means of a set of reducing rollers.

9. A process according to claim 8, wherein the coiled dough resulting from the first coiling step is turned through an angle before presentation to the reducing rollers.

10. A process according to claim 9, wherein the angle is about 90°.

11. A process according to claim 1, wherein the dough is subjected to the further steps of forming a sheet and coiling the sheet.

12. A process according to claim 1, wherein the dough is conveyed along a flow path which includes changes of direction corresponding to said angle.

13. A process according to claim 1, wherein the dough is allowed to rest after each coiling step.

14. A process according to claim 13, wherein the resting time is from 0 to 5 minutes.

15. A process according to claim 14, wherein the resting time is about 3 minutes.

16-17. (canceled)

18. A process for preparing a baked product comprising the step of baking a dough produced by the process of claim 1.

19. Dough prepared by the process of claim 1.

20. A baked product prepared by the process of claim 18.

21. Apparatus for preparing dough for baking, the apparatus comprising means for reducing a dough piece into a sheet, means for coiling the sheeted dough piece, means for presenting the coiled dough piece longitudinally to further reduction means to form a further sheet and means for coiling said further sheet.
